(19) United States
(12) Patent Application Publication
(10) Pub. No.: US 2005/0244777 A1
(43) Pub. Date: Nov. 3, 2005

(54) Buccal tube having flared mesial and distal ends

(76) Inventor: Charles J. Schultz, West Babylon, NY (US)

Correspondence Address: James B. Bieber, Esquire;DENTSPLY INTERNATIONAL INC., 570 West College Avenue, York, PA, 17404, US

(21) Appl. No.: 11/118,562

(22) Filed: Apr. 29, 2005

Related U.S. Application Data
(60) Provisional application No. 60/567,402, filed on Apr. 30, 2004.

(51) Int. Cl. A61C 3/00

(52) U.S. Cl. 433/17

(57) ABSTRACT

The invention is a buccal tube for securing an orthodontic wire to a tooth. The device includes a base or flange for attaching to a tooth and one or more tubes fixed to the base, each tube having a bore for receiving an arch wire. The tube bore includes mesial and distal ends and a center portion. The center bore portion has a shape and dimensions for receiving and securing the wire. Both the mesial and distal bore ends of the tube are flared to accommodate receiving the arch wire, particularly when extending an arch wire from a first mesial buccal tube to a second distal buccal tube as adjacent molars are engaged in the orthodontic process.

### FIELD OF INVENTION

This invention is directed to orthodontic devices, such as buccal and lingual tubes, for securing an orthodontic wire to a tooth. More particularly, the invention focuses upon buccal tube improvements that allow, as an orthodontic treatment progresses, easier extension and securing of an arch wire between two adjacent molars.

### BACKGROUND OF THE INVENTION

As orthodontic treatment progresses it is often necessary to extend an arch wire and secure it to an adjacent, usually most distal molar. In some cases it is required to apply aligning forces to a newly erupted second molar. In others, it is necessary to cinch up a wire as alignment and leveling improves and slack in a wire is created between visits.

To accommodate second molars, orthodontists have long utilized a buccal tube attached to a first molar having a convertible or removable cover. When it is time to extend an arch wire to a distal molar, a second buccal tube is attached to the second molar and the convertible cover of the first tube is removed, converting it, essentially, into a conventional bracket. This strategy has often been employed because it is so difficult to align and direct an arch wire end threaded through the first tube into the receiving bore of the second tube attached to an adjacent molar. Placing the arch wire into such a tube can be particularly challenging when the tooth is rotated or canted in relationship to the adjoining molar or bicuspid. A difficulty with convertible buccal tubes has been that the caps are prone to premature separation, repair of which typically requires welding or ligation, which is expensive in lost time and exposes the patient to materials that are not necessarily biocompatible and irritating.

Another strategy is that described, for example, in U.S. Pat. No. 5,556,277 wherein a buccal tube bore entry way was flared at its mesial end to allow greater access to extend and start the wire. A difficulty with this design is that the axial length of the tube portion contacting the arch wire often does not provide sufficient anchorage to keep the arch wire positioned accurately, leading to loss of control. The shorter span typically provided is prone to allow more flexible arch wires to escape the tube altogether.

The present inventor, in U.S. Pat. No. 6,705,862, described a combination of a convertible buccal tube with flaring of the arch wire entry way as a means of reducing stress on the cap during placement of the arch wire. The intent was to reduce strain on the cap during introduction of the arch wire to prevent premature separation of the cap. The difficulty with this arrangement is that, as in US '277, the shortened active span providing anchorage may compromise control, especially in conjunction with Class II elastics.

None of the solutions proposed to date have solved the inconvenient and difficult problem of feeding an arch wire from a first to a second molar. A bigger challenge, since the adjustment is made at the back of a patient's mouth, is to cinch or tighten an arch wire.

The wide spread use of more flexible NiTi “super” arch wires has not lessened the challenge, particularly with the problem of arch wires shifting out of the buccal tube. This is especially a problem with the shorter designs, such as noted above regarding US '277. It is generally recognized that with the NiTi wires, leveling and aligning is likely to happen quicker resulting in the wire either escaping from the shorter axial length tubes with wider openings or for the wire to poke out the posterior of the tube, either event requiring an inconvenient patient visit to the orthodontist for correction, adding cost and disrupting the patient's schedule in a manner incompatible with modern treatment modalities.

### SUMMARY OF THE INVENTION

This invention is designed to satisfy the need for increased control while allowing greater patient comfort and fewer office visits.

The invention provides an orthodontic device for securing a wire to a tooth, including a flange or base for attaching the device to a tooth, and; a tube fixed to the flange having a bore for receiving the wire, said tube bore having mesial and distal end portions and a center portion, wherein the center portion has a shape and dimensions for securing the wire. Both the mesial and distal bore ends of the tube are flared to more easily accommodate receiving the arch wire.

The buccal tube of the invention preferably includes a plurality of buccal tubes attached to adjacent teeth, each tube flared at its mesial and distal bore openings sufficiently such that an orthodontic arch wire is more easily extended from one tube to be secured in said adjacent tube.

The center portion of each tube is of sufficient axial length to retain the arch wire in the buccal tube without loss of control, a problem with the prior art.

### BRIEF DESCRIPTION OF THE DRAWINGS

FIG. 1 is a schematic showing of flared buccal tubes of the invention attached to adjacent molars securing an orthodontic arch wire to the tooth surfaces;

FIG. 2 is flared buccal tube of the invention, including twin buccal tubes;

FIG. 3 is an end view of the buccal tube of FIG. 2;

FIG. 4 is a plan view of the buccal tube of FIG. 2, further showing, by dashed hidden lines, the internal structure of the flared tube bores;

FIG. 5 is flared buccal tube of the invention showing three tubes for receiving various arch wires or auxiliary attachments.

### DETAILED DESCRIPTION OF THE INVENTION

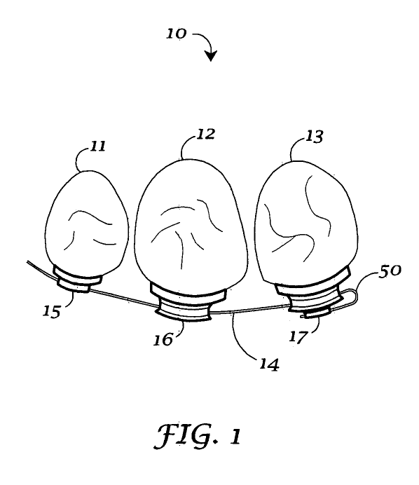

Referring to the drawings, FIG. 1 is a schematic of a portion of a patient's dentition (10) that is being orthodontically treated for malocclusion, including a bicuspid (11), a mesial first molar (12) and a distal second molar (13). An arch wire (14) is secured to the bicuspid by a conventional bracket (15) and to the molars by means of buccal tubes (16 and 17) of the invention.

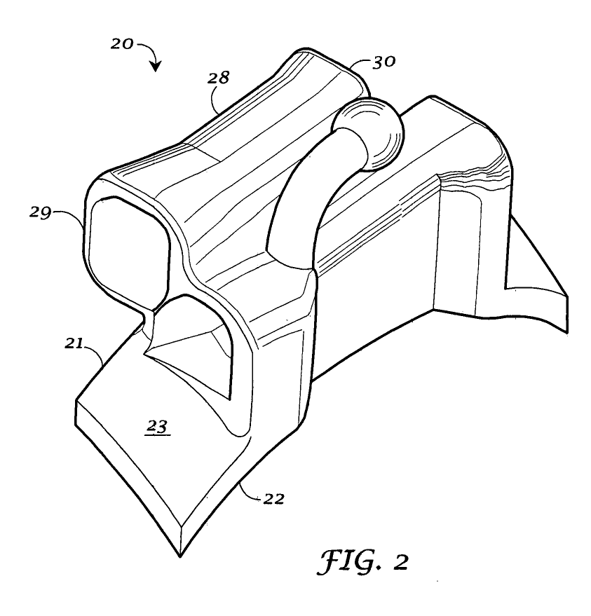

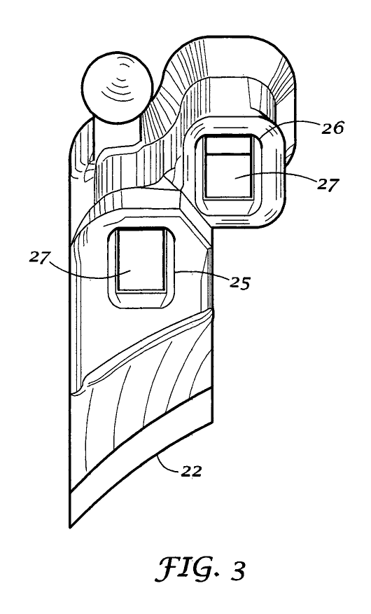

Referring to FIGS. 2-4, a buccal tube device of the invention similar to the buccal tube (17) attached to the distal molar (13) in FIG. 1 is shown in detail. FIG. 2 is an isometric projection of the twin tube orthodontic device (20).

The orthodontic device (20) of the invention, preferably includes a flange (21) having a base surface (22) for attachment to a tooth surface and an upper surface (23) for supporting the body or structure (24) for securing an arch wire, (not shown but similar to the arch wire (14) of FIG. 1). The device structure, as shown in the preferred embodiment of FIG. 2, includes two integrally formed buccal tubes (25, 26) generally axially aligned in parallel. A main tube (25) is provided with a rectangularly shaped bore (27) for slidably receiving an arch wire of similar shape and dimensions.

The auxiliary or adjacent tube (26) may include a bore (28) of similar dimensions to the main bore (25). It may, as is well known, be aligned or angled relative to the main bore and body to provide a desired torque or other effect in the treatment process.

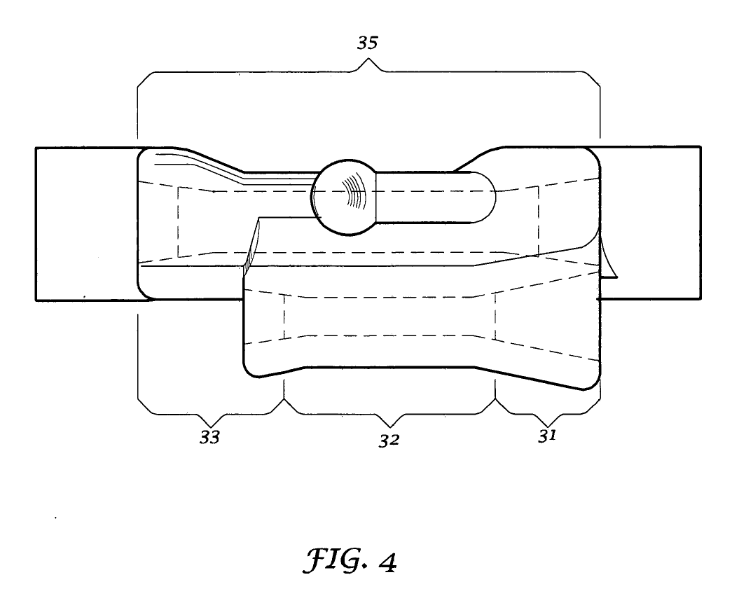

As shown in FIGS. 2 and 4, each of the buccal tube bores (25, 26) is flared, both at its mesial end (29) and distal bore end (30), to more easily accommodate receiving an arch wire. FIG. 4 shows the internal structure and dimensions in dashed outline, each buccal tube bore including a mesial portion (31), a center portion (32) and a distal end portion (33). An essential element of the center portion (32) is that it provide sufficient arch wire contact length to secure and control the arch wire. Lack of control surfaces has been a defect of prior art buccal tubes. Analysis shows that greater than at least about 3.5 mm of length is preferred for controlling a rectangular arch wire of typical mm dimensions, such as 0.46×0.46 mm (0.018×0.018 inch) or 0.508×0.508 mm (0.020×0.020 inch).

The buccal tube of the invention, while non-convertible, is preferably flared at its mesial portion (31) entryway for 0.5 to 1.5 mm of axial length for easier insertion of an arch wire. In addition, feeding the wire from the first to the second molar tube is enhanced by the distal portion (33) exit of the tube also being flared, preferably over 0.3 to 0.7 mm of axial length, giving the buccal tube of the invention a somewhat saddle-shaped appearance. The short flared distal end portion (33) enhances the breadth and utility of the flaring, as the wire is fed into the second molar tube that also has a widened mesial opening. The widened, flared short distal end (33) further allows a cinch-back (50) of excess wire (as shown in FIG. 1), eliminating a source of patient irritation found with traditional second molar tubes.

Providing adequate control of the arch wire is a critical feature of the buccal tube of the invention and, as noted above, research has shown that close, slidable contact of an adequate axial length is necessary, preferably at least 3.5 mm of true slot contact with the arch wire. Further, the longer length of the bore center portion contact tube (32) allows superelastic NiTi wires to work longer without escaping the tube or impinging on soft tissue. The difficulty is particularly a problem as the teeth level and align, wherein the wire needed to connect the malposed teeth is reduced. It is not unusual that 3-4 mm of wire would back out of the tube causing extreme patient discomfort and emergency visits. The buccal tube of the invention preferably provides an overall tube pathway (35) of overall length of at least about 5 mm long and less than 7 mm long, providing at least 3.5 mm of contact indicated by scientists as necessary to avoid anchorage loss.

The flared distal end portion (33) of the tube, preferably 0.3 to 0.7 mm of axial length, makes it possible to capture second molars earlier, a key to successful treatment. Early control of second molars prevents over-extrusion or impaction. The double “saddle” effect of the invention anticipates that second molars are most desirously treated for better long-term retention.

The buccal tubes of the invention can be welded to bands or attached to a base for adhesive bonding to a tooth surface, as their overall length is shorter than the buccal width of the smallest second molar. No change in treatment mechanics are needed, except that the orthodontist can expect enhanced results and better patient comfort using this design. No special tool is necessary for conversion. There is no worry of premature cap conversion, biological issues, and operator and patient comfort is greatly enhanced. Finally, the longer tube length assists in properly positioning on the tooth. Poorly positioned molars, as is possible with shorter tubes, can cause undesired rotations.

A preferred process for making the buccal tubes of the invention utilizes metal injection molding, which makes the more complex designs of the invention possible while maintaining strength and predictability. While such tubes could also be cast, they would not likely have the durability of an injection-molded tube. Precision angles and torques are easily introduced such that treatment is not compromised but enhanced due to this invention. The tubes can be flared vertically or horizontally in production.

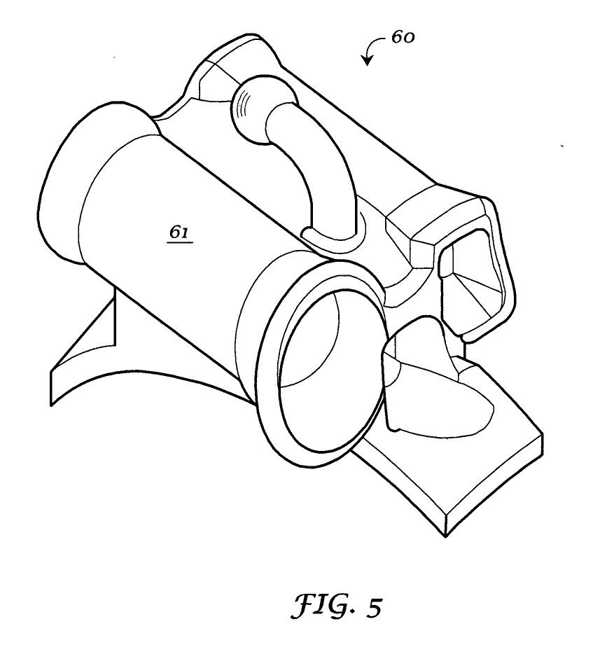

Referring to FIG. 5, an alternative buccal tube (60) embodiment of the invention is shown This embodiment includes twin buccal tubes for receiving and controlling arch wires, as in FIG. 2, but additionally includes a third flared buccal tube (61) having a bore of circular cross section. Such a tube with its flared receiving end portion is useful for receiving and securing auxiliary wires known in the art, such as lip bumpers and face bows.

While the invention has been described in detail above in several embodiments, it is to be understood that there are many well known features and variations that might be included, with the scope of the invention to be determined by the following claims.

1. An orthodontic device for securing a wire to a tooth, comprising:
a flange for attaching said device to said tooth; and
a tube fixed to said flange, said tube having a bore for receiving said wire, said tube bore having mesial and distal ends and a center portion, said center portion having a shape and dimensions for securing said wire;
wherein said mesial and said distal bore ends are flared to accommodate receiving said wire.

2. The device of claim 1 wherein said device is a buccal tube.

3. The buccal tube of claim 2 wherein a plurality of flared buccal tubes are attached to adjacent teeth, substantially in axial alignment, and said flared mesial and distal bore openings are sufficiently flared such that an orthodontic wire is extended through one tube and secured in said adjacent distal tube.

4. The buccal tube of claim 2 wherein tube bore center portion is at least about 3.5 mm in axial length.

5. The buccal tube of claim 2 wherein said distal flared end is shorter in axial length than the mesial flared end.

6. The device of claim 1 further comprising additional tubes having bores substantially in parallel alignment for receiving additional wires.

7. The buccal tube of claim 2 wherein the mesial end is flared vertically while the distal end is flared horizontally.

8. The buccal tube of claim 4 wherein central portion of said tube is about 5.5 mm in axial length.

9. The buccal tube of claim 2 wherein said mesial end flare is about 1.5 mm in axial length and 0.5 mm in axial length at the distal end.

10. The buccal tube of claim 2 wherein both mesial and distal ends are flared horizontally.

11. The buccal tube of claim 2 wherein both mesial and distal ends are flared vertically.

12. The buccal tube of claim 1 wherein said additional tubes are shorter in axial length than said first tube.

13. The device of claim 1 wherein said flange comprises a base portion for adhesively attaching to said tooth.

14. The device of claim 1 wherein said flange comprises attaching to a band for fitting to a tooth.
